(19) United States
(12) Patent Application Publication
(10) Pub. No.: US 2012/0151357 A1
(43) Pub. Date: Jun. 14, 2012

(54) PRESENTING DEVICE AVAILABILITY STATUSES

(75) Inventors: Graeme Andrew Kyle Roche, Seattle, WA (US); Allison O'Mahony, Bellevue, WA (US)

(73) Assignee: Microsoft Corporation, Redmond, WA (US)

(21) Appl. No.: 12/963,273

(22) Filed: Dec. 8, 2010

(51) Int. Cl. G06F 15/16; G06F 3/048

(52) U.S. Cl. 715/736

(57) ABSTRACT

A user of a set of devices may wish to view the availability statuses of respective devices (e.g., an indication of connectivity, and optionally associated information such as battery power and processor availability). However, users are often familiar with availability statuses (and the indicators representing such statuses) of contacts in a chat environment, such as “available,” “busy,” and “unavailable.” Therefore, device availability statuses may be presented using the same semantics and aesthetics of contact availability statuses, e.g., using the statuses and indicators of a chat environment, including an “available” (available and ready to provide services), “busy” (reachable but unable to provide services), and “unavailable” (unreachable). This user interface design may result in a more easily understandable semantics and a more visually consistent user experience.

### BACKGROUND

Within the field of computing, many scenarios involve a user of a set of one or more devices, such as one or more servers, workstations, notebook computers, mobile phones, digital cameras, or portable computing devices. These devices may be accessible to the user in various ways, such as via a computer network to which the device is connected.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

A user of a set of devices may wish to view the availability status of each device. For example, on a presentation device operated by the user (e.g., a workstation computer), the user may have identified the set of devices operated by the user, and may request a presentation of the current availability statuses of the devices. Each device may have various connectivity and/or availability statuses that indicate whether the device is currently accessible. The presentation device may therefore identify the availability of the devices (e.g., by attempting to contact each device and inquire as to its status), and may generate a presentation for the user that includes an indication of the availability status of each device.

However, the manner whereby the availability statuses are presented may have some advantages or disadvantages. In particular, the indication of the availability status may utilize different types of symbols, such as icons or pictorial representations, but the selection of symbols may affect the usability of the presentation. As a first example, some scenarios may utilize different indicator symbols for different devices or different device types (e.g., a first set of symbols to indicate the availability of a first device or device type, and a second set of symbols to indicate the availability of a second device or device type), but this disparity may cause a confusing or aesthetically inconsistent presentation. As a second example, some scenarios may utilize a consistent set of symbols for such indicators, but the symbols selected may be unsuitably abstract and/or unfamiliar, such that a user may have difficulty identifying the availability of a device based on the symbol presented to represent the availability. As a third example, some scenarios may represent the availability of the device using uncommon availability statuses, such as “limited connectivity,” “idle,” or “low resources,” that are not readily understood by all users (particularly by uses with limited technical skills).

The techniques presented herein relate to the presentation of availability statuses for devices that leverage users' familiarity with availability statuses of contacts in chat environments. Users often identify a set of contacts in a chat environment (such as an instant messaging system or a social network), and often utilize a client to initiate or participate in a conversation with such contacts. Chat clients often utilize a particular set of symbols (such as icons) to represent the contact availability statuses of respective contacts as “available,” ‘busy,” and “unavailable.” In accordance with the techniques presented herein, it may be advantageous to utilize the symbols used to represent the contact availability statuses of contacts in the chat environment in order to represent the device availability statuses of respective devices operated by the user. An embodiment of these techniques may store a set of indicators to represent various availability statuses, and may utilize the same set of indicators to represent the device availability statuses of respective devices as the contact availability statuses of respective contacts. For example, the device availability status of a device may be represented as “available,” “busy,” or “unavailable” in the same manner as contact availability statuses of respective contacts, and using the same icons to represent the availability statuses of both devices and contacts. The device availability statuses of the devices may therefore be presented in a manner that is already familiar to the users and that is visually and semantically consistent with the contact availability statuses of the contacts.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary scenario featuring a presentation to a user of availability statuses of devices.

FIG. 2 is an illustration of an exemplary scenario featuring a presentation to a user of availability statuses of devices and contacts in accordance with the techniques presented herein.

FIG. 3 is a flow chart illustrating an exemplary method of presenting to a user availability statuses of devices and contacts.

FIG. 4 is a component block diagram illustrating an exemplary system for presenting to a user availability statuses of devices and contacts.

FIG. 5 is an illustration of an exemplary computer-readable medium comprising processor-executable instructions configured to embody one or more of the provisions set forth herein.

FIG. 6 is an illustration of an exemplary scenario featuring a presentation to a user of availability statuses of devices using a device availability server.

FIG. 7 is an illustration of an exemplary scenario featuring another presentation to a user of availability statuses of devices and contacts in accordance with the techniques presented herein.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

Within the field of computing, many scenarios involve a user who operates a set of devices. Such devices may include stationary devices (e.g., one or more computer servers, workstations, and/or home theater systems) and/or portable devices (e.g., one or more notebook computers, tablet devices, mobile phones, personal data assistants, gaming devices, digital cameras, and/or portable media players). The set or respective subsets of these devices may be tightly coupled (e.g., as a set of interconnected devices that integrally interoperate and share data), loosely coupled (e.g., as a set of devices having sporadic or incidental connections that may occasionally communicate), and/or isolated (e.g., each device operating independently and possibly without any information about the other devices). Within such scenarios, the user may wish to identify a connectivity and/or availability status of the devices. For example, respective devices may vary in terms of connectivity to other devices via a communication network such as a local area network (LAN) such as a Wi-Fi network, a wide area network (WAN) such as the internet, or a cellular network; the communication bandwidth over such networks (e.g., inbound or outbound network bandwidth over a computer network); processor availability (e.g., a central processor busy or idle status); memory capacity (e.g., available storage space); and/or power capacity (e.g., connected to an unlimited power supply such as a wall outlet, or a charge remaining on a portable battery or uninterruptible power supply). The user may therefore wish to identify whether each device is available (e.g., having an operative communication connection to the user, and having sufficient resources, such as network, processor, storage, and power capacity, to perform tasks on behalf of the user).

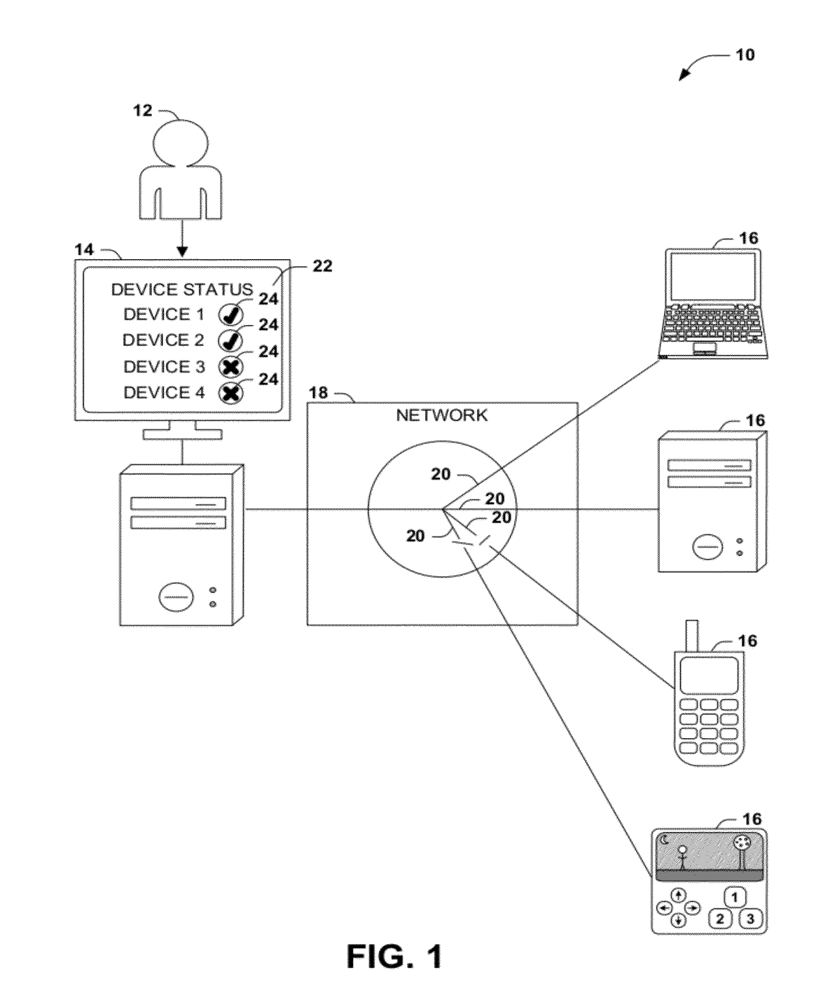

FIG. 1 presents an exemplary scenario 10 featuring a user 12 operating a set of devices 16, such as a first device 16 comprising a portable computer of a notebook form factor; a second device 16 comprising a stationary computer such as a server; a third device 16 comprising a mobile phone; and a fourth device 16 comprising a portable gaming device. The user 12 may operate a presentation device 14, such as a workstation computer having a display component (e.g., a liquid crystal display (LCD) monitor), that may be connected to the devices 14 via a communication network 18, such as, a wired local area network (LAN), a Wi-Fi wireless network, or a wide-area network (WAN) such as the internet. Within this communication network 18, respective devices 16 may establish a connectivity status 20 with other devices 16 based on the capability of intercommunication. For example, the user 12 may operate a presentation device 14, such as a computer having a display component and software configured to identify the connectivity status 20 of the presentation device 14 with the other devices 16. The presentation device 14 may therefore present, for respective devices 16, a device availability status 24 indicating whether or not the presentation device 14 is capable of communicating with each device 16. For example, the presentation device 14 may be capable of communicating with a first device 16 and a second device 16 and may therefore present an “available” device availability status 24 for these devices 16, but may be capable of communicating with a third device 16 and a fourth device 16 and may therefore present an “unavailable” device availability status 24 for these devices 16. In this manner, the presentation device 14 may generate for the user 12 a presentation 22 indicating the device availability status 24 of each device 16.

Many ways of presenting the device availability statuses 24 of respective devices 16 may be devised. However, when evaluated in the context of the field of user experience (UX), some presentations 22 of device availability statuses 24 may be identified as presenting advantages or disadvantages with respect to other presentations 22 of device availability statuses 24 of the devices 16. As a first example, in some embodiments, different indicators may be utilized to indicate the device availability statuses 24 of different device 16, or of different device types (e.g., a first set of icons may be presented to indicate a device availability status 24 of a first device 16 or device type, and a second set of icons may be presented to indicate a device availability status 24 of a second device 16 or device type). However, the use of different types of icons may lead to an inconsistent or confusing experience. As a second example, in some embodiments, the device availability status 24 may be reported using symbols (such as icons or pictures) that are difficult to interpret. For example, symbols comprising abstract shapes or color-coding, or that utilize icons with too much or too little detail, may be difficult for a user 12 to interpret correctly as a represented device availability status 24 of a device 16. As a third example, some embodiments may present device availability statuses 24 of devices 16 that provide technical information about the state of the device, such as “limited connectivity,” “idle,” or “low resources” (e.g., low memory or processor capacity). While this information may provide useful technical information about the state of the device, the information conveyed by these indicators about the device availability status 24 of the device 16 may not be readily understood by all users 12, particularly by users 12 with limited technical skills or experience.

Presented herein are techniques for presenting the device availability status 24 of one or more devices 16 that may present an improved usability with respect to other techniques. It may be appreciated that users 12 may be familiar with the availability statuses of one or more contacts. For example, a user 12 may have established a set of contacts in a social network or chat application, and may request a presentation of the contact availability statuses of the contacts. Each contact may report his or her contact availability status, e.g., as an “available” status indicating that the contact is available to chat; a “busy” status indicating that the contact is available, but wishes not to be contacted; and an “unavailable” status indicating that the contact is not available). In order to present the contact availability status of each contact, the presentation device 14 of the user 12 may utilize a set of symbols, and the user 12 may be familiar with these symbols and the meaning conveyed by each.

Therefore, and in accordance with the techniques presented herein, the presentation device 14 of the user 12 may be configured to present the device availability statuses 24 of respective devices 16 using the set of indicators that are used to represent the contact availability statuses of various contacts. For example, the chat environments may have established and made familiar to the user 14 a set of contact availability indictors to indicate that various contacts, such as “available,” “busy,” and “unavailable.” Accordingly, the device availability statuses 24 of respective devices 16 may be similarly represented as an “available” status where the device 16 is accessible and is available to handle requests of the user 12; a “busy” status, where the device 16 is accessible but is not currently available to handle requests of the user 12 (e.g., where the device 16 is performing a high volume of computing tasks and has little available computational bandwidth, or where the device is handling a significant amount of network traffic and has little available network bandwidth); and an “unavailable” status where the device 16 is unreachable (e.g., where the device is powered down, not connected to the network, or otherwise not accessible). Additionally, the presentation device 14 may utilize a set of indicators (such as icons) as visual representations of the contact availability statuses of the contacts. An embodiment of these techniques may therefore represent the device availability statuses 24 of the devices 16 using the same indicators used to represent the contact availability statuses of the contacts. In some embodiments, the availability statuses of devices 16 and contacts may even be commingled into a single availability set, using a consistent set of icons and availability statuses for both contacts and devices 16. In this manner, the presentation of device availability statuses 24 of devices 16 may draw on the established consistency and resident familiarity of contact availability statuses of contacts, resulting in an improved user experience.

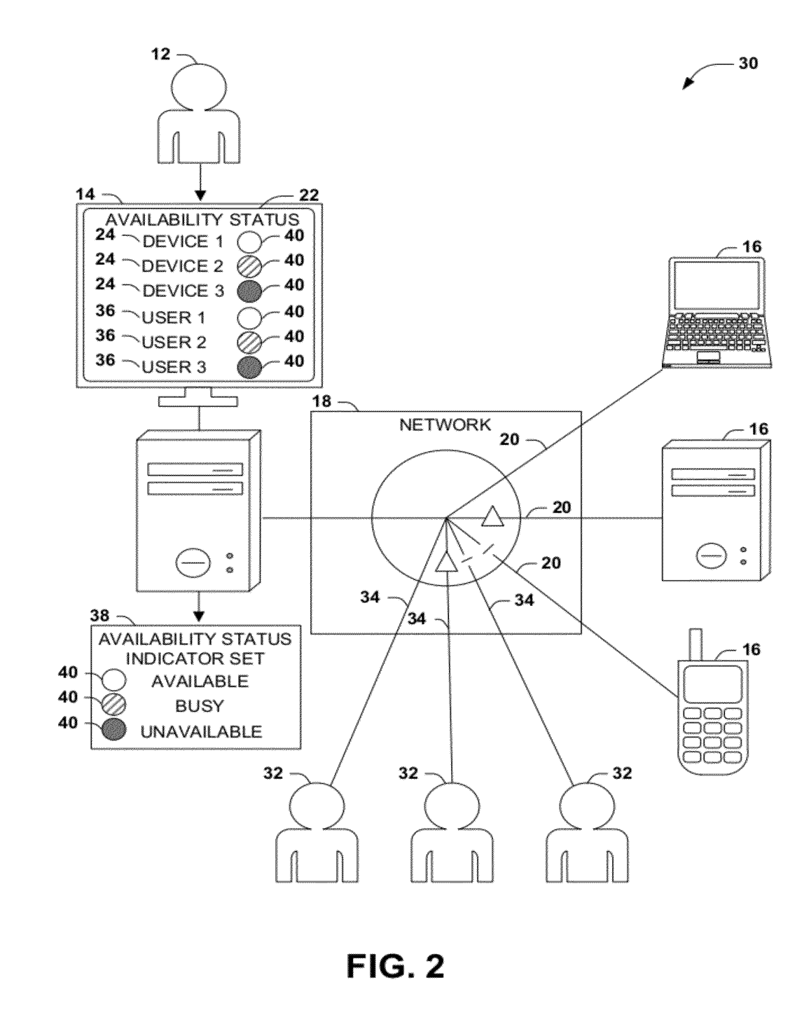

FIG. 2 presents an exemplary scenario 30 featuring one possible use of the techniques presented herein. In this exemplary scenario 30, a user 12 operates a presentation device 14 to interact with a set of devices 16, each of which may have a particular connectivity status 20 with respect to the presentation device 14 (e.g., a first device 16 may be connected with the presentation device 14, but a third device 16 may be disconnected from the presentation device 14). Additionally, some devices 16 (such as the second device 16) may be connected to the presentation device 14, but may be unable to handle new request or new tasks, e.g., due to high processor utilization or low bandwidth or storage space. Additionally, the user 12 may have developed relationships with one or more contacts 32, such as in a chat environment or a social network. The presentation device 14 may therefore inform the user 12 of the connectivity status 20 of respective contacts 32; e.g., first contact 32 may be online and available to chat, while a second contact 32 may be online but unavailable to chat (e.g., away at a meeting or occupied with a particular task), and a third contact 32 may be offline. In order to present this information to the user 12, the presentation device 14 may store an availability status indicator set 38, comprising a set of availability status indicators 40 (e.g., icons, pictures, or symbols) that represent different availability statuses, such as “available,” “busy,” and “unavailable.” In accordance with the techniques presented herein, the presentation device 14, having detected the device availability statuses 24 of respective devices 16 and the contact availability statuses 36 of respective contacts 32 by utilizing the availability status indicators 40 of the availability status indicator set 38. The presentation device 14 therefore achieves the presentation 22 of device availability statuses 24 of devices 16 with the readily understandable semantics of contact availability statuses 36 of contacts 32 in the chat environment, and using a visually consistent set of availability status indicators 40. Additionally, this exemplary scenario 30 presents the device availability statuses 24 of the devices 16 in one area of the presentation 22 and the contact availability statuses 36 of the contacts 32 in a different area of the presentation 22, but other embodiments may commingle these availability statuses (e.g., by sorting the devices 16 and the contacts 32 together in alphabetical order, and presenting the availability statuses 36 thereof in a single area of the presentation 22).

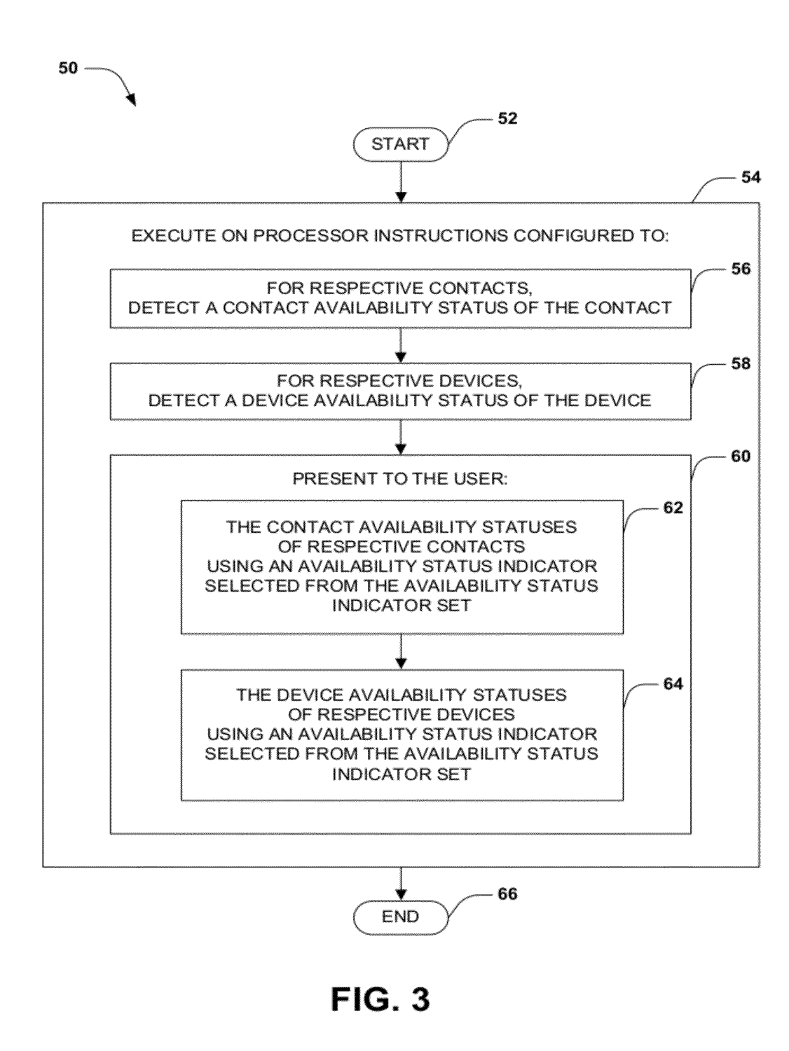

FIG. 3 presents a first embodiment of these techniques, illustrated as an exemplary method 50 configured to present availability statuses of devices 16 and contacts 32 to a user 12. The exemplary method 50 may be implemented, e.g., as a set of software instructions stored in a memory component (e.g., system memory, a platter of a hard disk drive, a solid-state storage device, or a magnetic or optical disc) of a presentation device 14 (e.g., a workstation, a notebook computer, a tablet computer, or a mobile phone), such that when the instructions are executed on a processor of the presentation device 14 having access to an availability status indicator set 38 including an available indicator, a busy indicator, and an unavailable indicator, cause the presentation device 14 to utilize the techniques presented herein. The exemplary method 50 begins at 52 and involves executing 54 the instructions on the processor. In particular, the instructions are configured to, for respective contacts 32, detect 56 a contact availability status 36 of the contact 32. The instructions are also configured to, for respective devices 16, detect 58 a device availability status 24 of the device 16. The instructions are also configured to present 60 to the user 12 the contact availability status 62 of respective contacts 32 using an availability status indicator 40 selected from the availability status indicator set 38, and the device availability status 64 of respective devices 16 using an availability status indicator 40 selected from the availability status indicator set 38. In this manner, the exemplary method 50 causes a presentation device 14 to present the availability statuses of the devices 16 and contacts 32 according to the techniques presented herein, and so ends at 66.

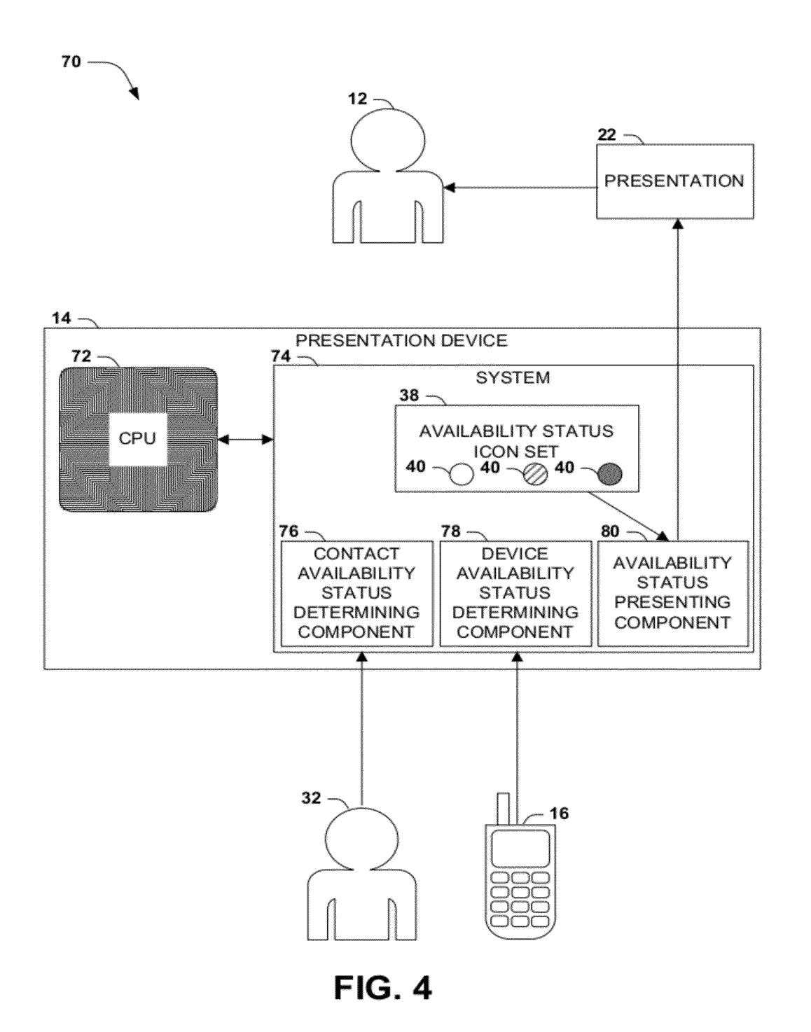

FIG. 4 presents a second exemplary embodiment of these techniques, illustrated as an exemplary system 74 operating on a presentation device 14 having a processor 72. The presentation device 14 is operated by a user 12 who also operates at least one device 16, and who has established a relationship with at least one contact 32. Within this presentation device 14, the exemplary system 74 may be implemented, e.g., as a set of interoperating software components, each comprising a set of instructions stored in a memory component (e.g., system memory, a platter of a hard disk drive, a solid-state storage device, or a magnetic or optical disc) of the presentation device 14 (e.g., a workstation, a notebook computer, a tablet computer, or a mobile phone), where the instructions are configured to cause the processor 72 to perform one or more tasks. The components of the exemplary system 74 (each executed concurrently and/or consecutively by the processor 72) may interoperate to perform the set of tasks comprising the techniques presented herein. The exemplary system 74 includes an availability status indicator set 38, including an available indicator, a busy indicator, and an unavailable indicator. The exemplary system 74 also includes a contact availability status determining component 76, which is configured to, for respective contacts 32, detect a contact availability status 36 of the contact 32. The exemplary system 74 also includes a device availability status determining component 78, which is configured to, for respective devices 16, detect a device availability status 24 of the device 16. The exemplary system 74 also includes an availability status presenting component 80, which is configured to present to the user 12 the contact availability status 36 of respective contacts 32 using an availability status indicator 40 selected from the availability status indicator set 38, and the device availability status 24 of respective devices 16 also using an availability status indicator 40 selected from the availability status indicator set 38. In this manner, the components of the exemplary system 74 of FIG. 4, when executed on the processor 72 of the presentation device 14, cause the presentation device 14 to utilize the techniques presented herein.

Still another embodiment involves a computer-readable medium comprising processor-executable instructions configured to apply the techniques presented herein. Such computer-readable media may include, e.g., computer-readable storage media involving a tangible device, such as a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD-R, DVD-R, or floppy disc), encoding a set of computer-readable instructions that, when executed by a processor of a device, cause the device to implement the techniques presented herein. Such computer-readable media may also include (as a class of technologies that are distinct from computer-readable storage media) various types of communications media, such as a signal that may be propagated through various physical phenomena (e.g., an electromagnetic signal, a sound wave signal, or an optical signal) and in various wired scenarios (e.g., via an Ethernet or fiber optic cable) and/or wireless scenarios (e.g., a wireless local area network (WLAN) such as WiFi, a personal area network (PAN) such as Bluetooth, or a cellular or radio network), and which encodes a set of computer-readable instructions that, when executed by a processor of a device, cause the device to implement the techniques presented herein.

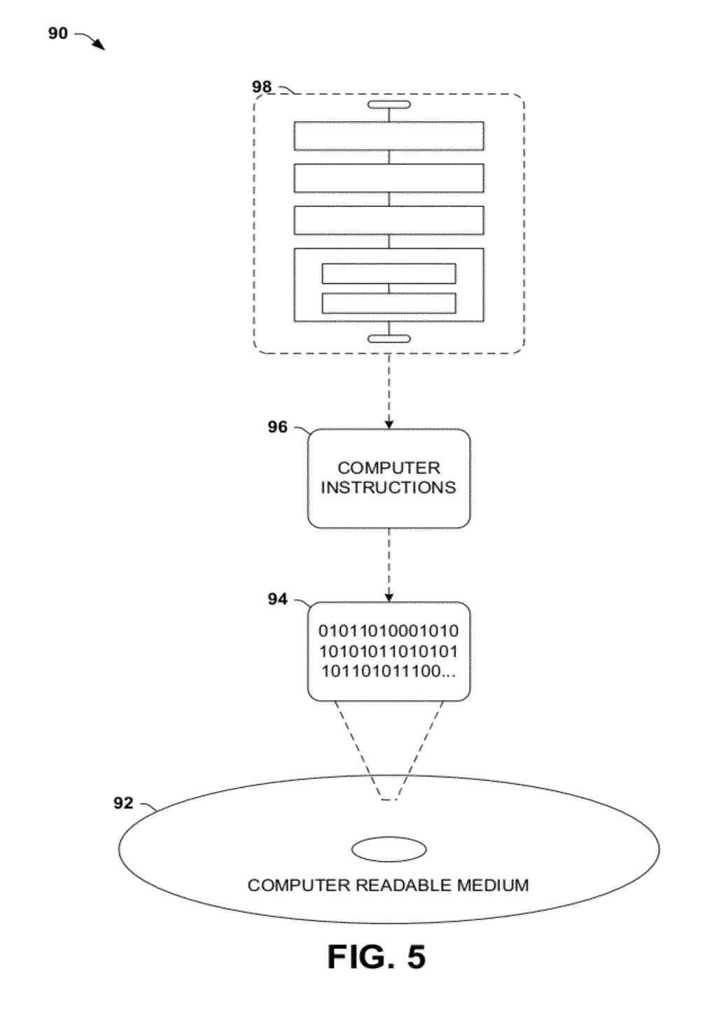

An exemplary computer-readable medium that may be devised in these ways is illustrated in FIG. 5, wherein the implementation 90 comprises a computer-readable medium 92 (e.g., a CD-R, DVD-R, or a platter of a hard disk drive), on which is encoded computer-readable data 94. This computer-readable data 94 in turn comprises a set of computer instructions 96 configured to operate according to the principles set forth herein. In one such embodiment, the processor-executable instructions 96 may be configured to perform a method of presenting to a user availability statuses of devices and contacts, such as the exemplary method 50 of FIG. 3. In another such embodiment, the processor-executable instructions 96 may be configured to implement a system for presenting to a user availability statuses of devices and contacts, such as the exemplary system 74 of FIG. 4. Some embodiments of this computer-readable medium may comprise a nontransitory computer-readable storage medium (e.g., a hard disk drive, an optical disc, or a flash memory device) that is configured to store processor-executable instructions configured in this manner. Many such computer-readable media may be devised by those of ordinary skill in the art that are configured to operate in accordance with the techniques presented herein.

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary method 50 of FIG. 3 and the exemplary system 74 of FIG. 4) to confer individual and/or synergistic advantages upon such embodiments.

A first aspect that may vary among embodiments of these techniques relates to the scenarios wherein such techniques may be utilized. As a first example, these techniques may be utilized to present device availability statuses 24 for many types of devices 16, including stationary devices (e.g., one or more computer servers, workstations, and home theater systems) and/or portable devices (e.g., one or more notebook computers, tablet devices, mobile phones, personal data assistants, gaming devices, digital cameras, and portable media players). Such devices may be owned by the user 12, or may be owned by another individual or organization (such as the employer of the user 12) and provided to the user 12 for operation. As a second example of this first aspect, these techniques may be utilized to present contact availability statuses 36 for many types of contacts, including email contacts, chat environment contacts (such as contacts in an instant messaging network), social network contacts, and physical presence contacts (e.g., a group of users who share geolocation information with each other, such as detected and reported by a global positioning system (GPS) receiver, or by a physical identifier, such as a radiofrequency identification (RFID) chip detected by an RFID reader). Those of ordinary skill in the art may devise many scenarios wherein these techniques may be utilized.

A second aspect that may vary among embodiments of these techniques relates to the detection of device availability statuses 24 and/or contact availability statuses 36 of respective devices 16 and contacts 32. As a first variation of this second aspect, the device availability statuses 24 and/or contact availability statuses 36 may be detected directly by the presentation device 14. For example, the presentation device 14 may send a device availability query to a device 16 (e.g., a ping request), and may receive a device availability report (e.g., a ping reply) from the device 16 to indicate an available status. Conversely, a device 16 that responds in a delayed manner may be presumed to have a busy status, and a device 16 that fails to respond with a device availability report may be presumed to have an unavailable status. Alternatively or additionally, the devices 16 may also notify the presentation device 14 without prompting (e.g., by sending a device availability report at a particular frequency, such as once per hour). Similar techniques may be used to detect the contact availability statuses 36 of various contacts 32.

As a second variation of this second aspect, the devices 16 may report device availability statuses 24 to a device availability server, such as a server or service accessible over a network (such as the internet) and configured to accept such device availability statuses 24 and report the set of such statuses (e.g., to a presentation device 14 operated by the user 12). As a first such example, the devices 16 may communicate with a device availability server in a loosely coupled manner, reporting only the device availability status 24 of the device 16 and optionally some other information, such as the device state of the device 16 (e.g., a power capacity of a battery or an amount of free memory). Alternatively, the devices 16 may comprise a mesh of interoperating devices that are tightly coupled with a mesh server, which is configured to manage and synchronize the data on each device 16 to provide a consistent computing environment to the user 12. For example, when a user 12 chooses to create, update, delete, or move an object; install, configure, or uninstall an application; or change a setting of the computing environment, the mesh server may synchronize the changes with all devices 16 of the mesh in order to provide a consistent computing environment to the user 12 across all devices 16. In accordance with the techniques presented herein, the mesh server may also operate as a device availability server that is configured to notify devices 16 of the device availability statuses 24 of other devices 16 comprising the mesh. In some such variations, the presentation device 14 may also be included in the mesh, and may be configured to report its device availability status 32 to the device availability server for reporting to other devices 16 that may be used by the user 12 as a presentation device 14. Similar techniques may be utilized with respect to the contact availability statuses 36 of contacts 32 (e.g., contacts 32 may report contact availability statuses 36 directly to the presentation device 14, or to a contact availability server, such as a chat server).

Some additional variations of this second variation of this second aspect involve the relationship between the devices 16 (optionally including the presentation device 14) and the device availability server. As a first such variation, the devices 16 may spontaneously report a device availability status 24 at an availability frequency (e.g., once an hour). Alternatively or additionally, the device availability server may initiate a device availability query, and the devices 16 may be configured to receive the device availability query and return a device availability report of the device availability status 24 of the device 16. For example, the devices 16 may periodically report device availability statuses 24, but when the user 12 requests a presentation 22 on a presentation device 14, the device availability server may send device availability reports (e.g., to devices 16 that have not reported a device availability status 24 in the last five minutes) in order to receive and present to the user 12 an updated set of device availability statuses 24. As a second such variation, the device availability server may also collect from the devices 16 and report to the user 12 a device status of respective devices 16, such as remaining battery capacity or remaining memory or storage space.

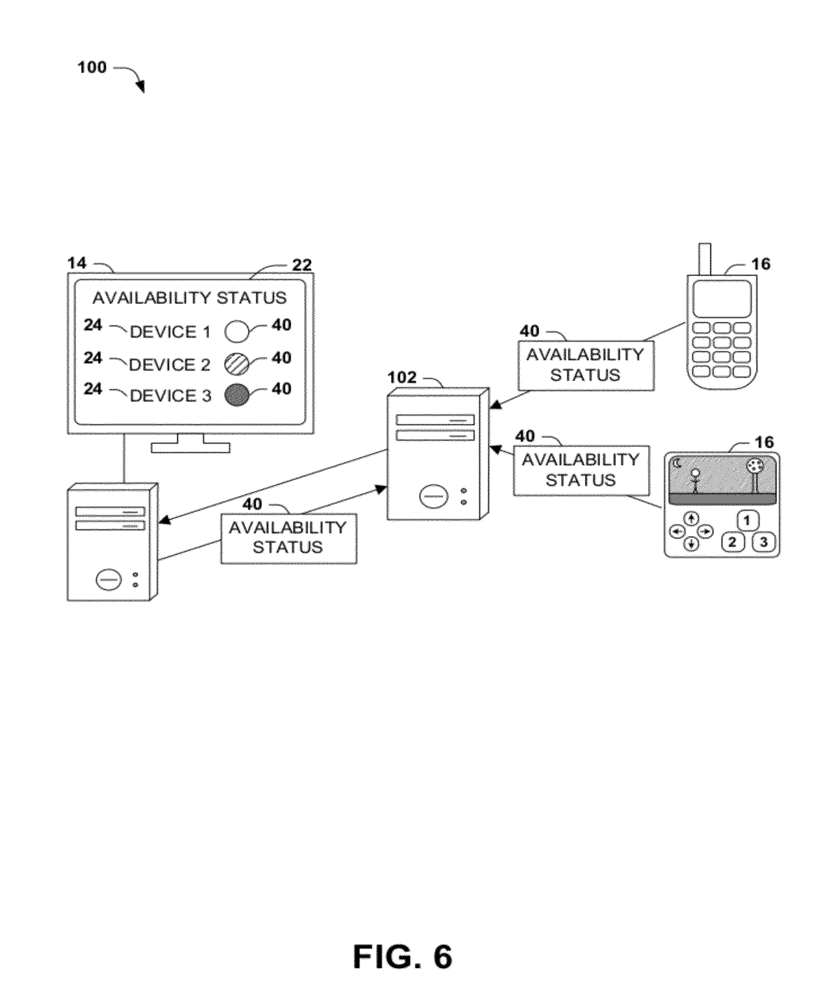

FIG. 6 presents an illustration of an exemplary scenario 100 featuring a few variations of this second aspect. In this exemplary scenario 100, a device availability server 102 is provided that collects device availability statuses 24 from respective devices 16 operated by the user 12 and reports such device availability statuses 24 to the presentation device 14, which presents the device availability statuses 24 of respective devices 16 using the same availability status indicators 40 as for presenting the contact availability statuses 36 of respective contacts 32. Moreover, the presentation device 14 also reports its device availability status 24 to the device availability server 102, e.g., for reporting to the other devices 16 of the user 12. In this manner, the device availability server 102 mediates the reporting of device availability statuses 24 of respective devices 16 and communication with the presentation device 14. Those of ordinary skill in the art may devise many ways of implementing the reporting of device availability statuses 24 to the user 12 while implementing the techniques presented herein.

A third aspect that may vary among embodiments of these techniques relates to the presentation 22 of device availability statuses 24. As a first example of this third aspect, the availability status indicator set 38 may not be limited to “available,” “busy,” and “unavailable” statuses, but may include availability status indicators 40 that are associated with additional device availability statuses 24 that coincide with the contact availability statuses 36 of one or more contacts 32. For example, the device availability statuses 24 may include an “asleep” status for devices 16 that are in a “suspended” or “hibernation” power state and are currently unreachable, but that may be powered on and ready for communication in a short time frame.

As a second example of this third aspect, along with the device availability status 24 of a device 16, the presentation 22 may include a device availability status message that describes the device availability status 24. For example, in addition to an availability status indicator 40, the presentation 22 may provide a textual description of the represented device availability status 24. This variation may be advantageous, e.g., for users 12 who are not yet familiar with the semantics of contact availability statuses 36 of contacts 32, and may be included in addition to the availability status indicator 40 that is presented for users 12 who are familiar with the semantics of contact availability statuses 36. Additionally, if a user 12 is associated with a particular culture (e.g., a user 12 who has indicated a language that the user 12 understands), the presentation 22 may select the device availability status message from a set of device availability status messages associated with different cultures (e.g., a database of strings comprising language- or culture-specific device availability status messages for respective device availability statuses 24).

As a second variation of this second example of this third aspect, in addition to an availability status indicator 40 representing a device availability status 24 of a device 16 (and/or a contact availability status 36 of a contact 32), the presentation 22 may include additional information about respective devices 16 and/or contacts 32. As a first such variation, the presentation 22 may include, for a particular device 16, a device depiction of the device 16, which may assist the user 12 in identifying the device 16 represented by a device availability status 22. The device depiction of the device 16 may be authentic (e.g., a picture of the device 16) or stylized (e.g., a drawing or cartoon of the device 16), and may illustrate the particular device 16 or any device 16 of a particular device type (e.g., a first device depiction for any notebook computer, a second device depiction for any tablet computer, and a third device depiction for any mobile phone). In the latter variation, the presentation 22 may determine the device type of a particular device 16, and may then present, with a device availability indicator 24 of the device 16, the device depiction for the device type of the device 16.

As a third variation of this second example of this third aspect, the presentation 22 of a device availability status 24 for a particular device 16 may include a device state indicator of a particular aspect of the device state of the device 16. For example, the device state of a device 16 may include various capabilities (e.g., the inclusion of a speaker or other sound output component, a webcam or other video input component, and a keyboard or other text-entry input component) and/or various properties (e.g., the power status of the device 16, the amount of available system memory or storage, the processor load, or the number of running threads), and the presentation 22 may include this device state information by including one or more device state indicators with the device availability status 24 of the device 16.

As a fourth variation of this second example of this third aspect, the presentation 22 of device availability statuses 24 may include device availability statuses 24 of one or more devices 16 that are operated by another user (other than the user 12 operating the presentation device 14). For example, a second user may have granted access to the user 12 regarding the device availability status 24 of various devices 16, such as in a family or company that provides a set of devices for a set of users 12, and each user 12 may be permitted to view the device availability statuses 24 of the devices 16 of the second user. The device availability statuses 24 of these devices 16 of the second user may therefore be included in the presentation 22. Additionally, the presentation 22 may associate the contact availability status 36 of a contact 32 with a device availability status 24 of a device 16 operated by that contact 32; e.g., if a contact 32 is using a particular device 16 to maintain availability (such as a particular mobile phone whereby the contact 32 may be reachable, or a particular network-connected computer by which the contact 32 is reachable over the internet), the presentation 22 may correlate the device availability status 24 of the device 16 with the contact availability status 36 of the contact 32 using the device 16.

As a fifth variation of this second example of this third aspect, the presentation device 14 may position the device availability statuses 24 of respective devices 16 in a first region of the presentation 22, and the contact availability statuses 36 of respective contacts 32 in a second region of the presentation 22. Alternatively, the device availability statuses 24 and contact availability statuses 36 may be presented together in the presentation 22, e.g., by sorting the availability status together in alphabetic order, or by presenting the contact availability statuses 36 of respective contacts 32 in association with the device availability statuses 24 of the devices 16 operated by those contacts 32.

As a third example of this third aspect, the presentation 22 may include, for a particular device 16, one or more device actions that may be taken with respect to the device 16. As a first such example, for a particular device 16 comprising a data store that stores data, the presentation 22 may include device actions such as viewing the data, altering the data, sending the data to another device 16, backing up the data to a backup device, or synchronizing the data with another version of the data store. As a second such example, for a particular device 16 comprising a camera, the presentation 22 may include device actions such as viewing the current output of the camera, capturing a picture or video using the camera, or adjusting the camera properties of the camera (e.g., the angle, zoom level, aperture size, or white balance of the camera). Additionally, for a device 16 having a particular device availability status 24, the presentation 22 may include device actions associated with that device availability status 24; e.g., for a device 16 that is “busy,” the presentation device 14 may present options such as viewing the causes of the busy status, and for a device 16 that is “unavailable,” the presentation device 14 may present options such as identifying the last time that the device 16 reported an “available” status. Moreover, the presentation 22 may include device actions that are associated not only with the device availability status 16 of the device 16, but also with the device availability status 16 of a second device 16 (e.g., if two devices 16 both have an “available” status, initiate a data synchronization therebetween), and/or with the contact availability status 36 of a contact 32 (e.g., if a device 16 reports an “unavailable” status and a contact 32 reports an “available” status, send a message to the contact 32 asking to investigate the reasons for the “unavailable” status of the device 16).

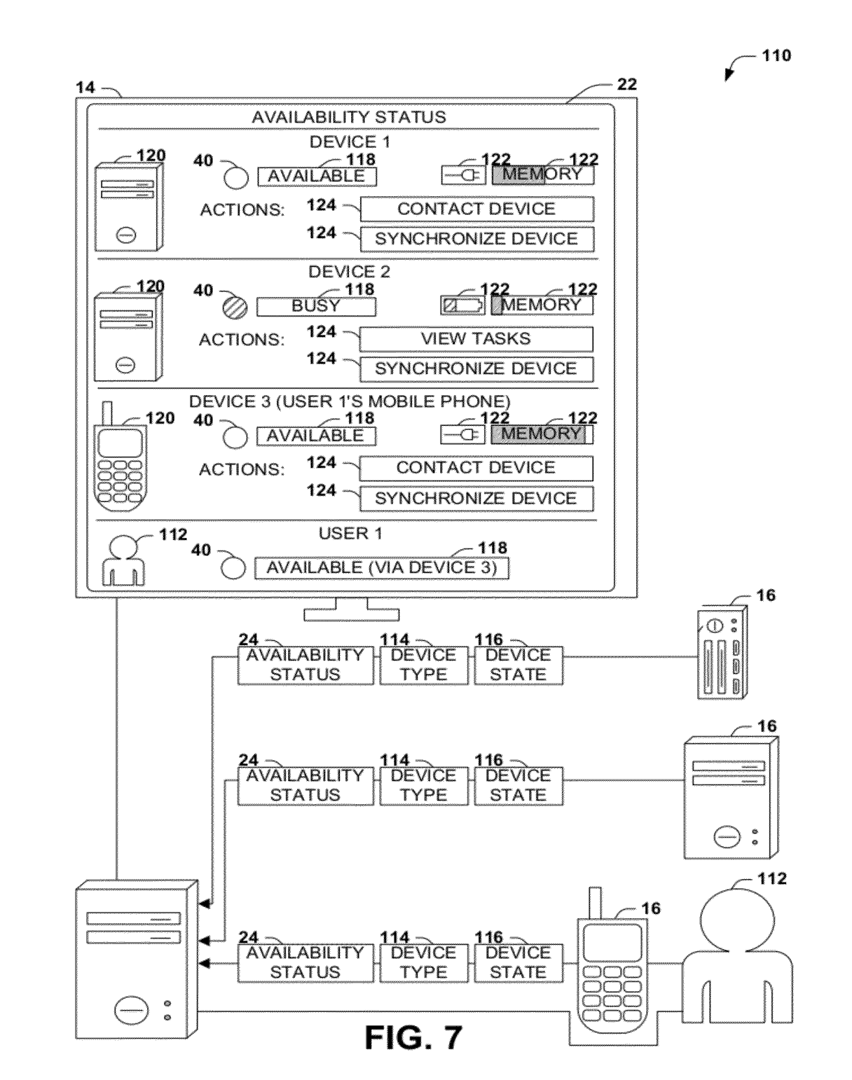

FIG. 7 presents an illustration of an exemplary scenario 110 featuring several variations of this third aspect in the presentation 22, to a user 12 of a presentation device 14, of device availability statuses 24 of respective devices 16 (and contact availability statuses 36 of users 32). As a first example, the set of devices 16 for which device availability statuses 24 are reported includes a device 16 operated by a second user 112, such as a contact 32 of the user 12. The presentation 22 includes both the device availability status 24 of the device 16 operated by the second user 112, and also the contact availability status 36 of the second user 112. As a second example, in addition to a device availability status 24, each device 16 reports its device type 114 (e.g., a workstation computer, a notebook computer, a tablet computer, a palmtop computer, or a mobile phone computer), and in addition to the availability status indicator 40 for a device 16, the presentation 22 includes a device depiction 120 of the device type 114 of the device 16 As a third example, a device availability status message 118 is included to describe each device availability status 24. As a fourth example, in addition to a device availability status 24, each device 16 reports a device state, such as power status (e.g., connected to a wall outlet or operating on battery power), and the presentation 22 includes device state indicators 122 describing the device state of a device 16 along with the device availability status 24 of the device 16. As a fifth example, the second user 112 operates the third device 16, and the presentation 22 associates the contact availability status 36 of the second user 112 with the device availability status 36 of the third device 32 (e.g., listing the device 16 operated by the second user 112 in order to achieve an “available” status). As a sixth example, the presentation 22 presents the device availability statuses 24 of the devices 16 together with the contact availability statuses 36 of the contacts 32. As a seventh example, for each device 16, one or more device actions 124 are included in the presentation 22, where the device actions 124 for a device 16 are associated with the device availability status 24 of the device 16 (e.g., the first device 16 has an “available” status, so the device actions 124 include contacting the device, while the second device 16 has a “busy” status, so the device actions 124 include viewing the tasks currently executed by the device 16). In this manner, many variations of this third aspect are included in the presentation 22 of device availability statuses 24 of respective devices 16. Those of ordinary skill in the art may devise many variations of the presentation 22 of device availability statuses 24 while implementing the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

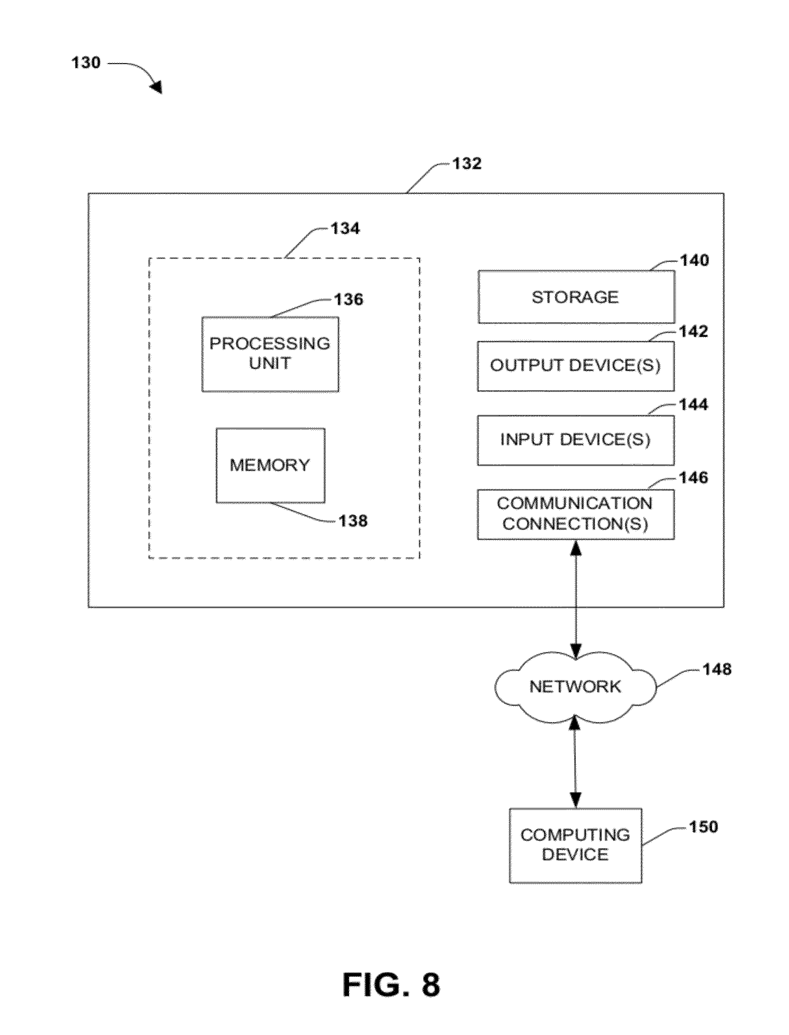

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 130 comprising a computing device 132 configured to implement one or more embodiments provided herein. In one configuration, computing device 132 includes at least one processing unit 136 and memory 138. Depending on the exact configuration and type of computing device, memory 138 may be volatile (such as RAM, for example), non-volatile (such as ROM, flash memory, etc., for example) or some combination of the two. This configuration is illustrated in FIG. 8 by dashed line 134.

In other embodiments, device 132 may include additional features and/or functionality. For example, device 132 may also include additional storage (e.g., removable and/or non-removable) including, but not limited to, magnetic storage, optical storage, and the like. Such additional storage is illustrated in FIG. 8 by storage 140. In one embodiment, computer readable instructions to implement one or more embodiments provided herein may be in storage 140. Storage 140 may also store other computer readable instructions to implement an operating system, an application program, and the like. Computer readable instructions may be loaded in memory 138 for execution by processing unit 136, for example.

The term “computer readable media” as used herein includes computer storage media. Computer storage media includes volatile and nonvolatile, removable and non-removable media implemented in any method or technology for storage of information such as computer readable instructions or other data. Memory 138 and storage 140 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 132. Any such computer storage media may be part of device 132.

Device 132 may also include communication connection(s) 146 that allows device 132 to communicate with other devices. Communication connection(s) 146 may include, but is not limited to, a modem, a Network Interface Card (NIC), an integrated network interface, a radio frequency transmitter/receiver, an infrared port, a USB connection, or other interfaces for connecting computing device 132 to other computing devices. Communication connection(s) 146 may include a wired connection or a wireless connection. Communication connection(s) 146 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 132 may include input device(s) 144 such as keyboard, mouse, pen, voice input device, touch input device, infrared cameras, video input devices, and/or any other input device. Output device(s) 142 such as one or more displays, speakers, printers, and/or any other output device may also be included in device 132. Input device(s) 144 and output device(s) 142 may be connected to device 132 via a wired connection, wireless connection, or any combination thereof. In one embodiment, an input device or an output device from another computing device may be used as input device(s) 144 or output device(s) 142 for computing device 132.

Components of computing device 132 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 132 may be interconnected by a network. For example, memory 138 may be comprised of multiple physical memory units located in different physical locations interconnected by a network.

Those skilled in the art will realize that storage devices utilized to store computer readable instructions may be distributed across a network. For example, a computing device 150 accessible via network 148 may store computer readable instructions to implement one or more embodiments provided herein. Computing device 132 may access computing device 150 and download a part or all of the computer readable instructions for execution. Alternatively, computing device 132 may download pieces of the computer readable instructions, as needed, or some instructions may be executed at computing device 132 and some at computing device 150.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of presenting availability statuses of devices and contacts to a user of a computer having a processor and an availability status indicator set including an available indicator, a busy indicator, and an unavailable indicator, the method comprising:
executing on the processor instructions configured to:
for respective contacts, detect a contact availability status of the contact;
for respective devices, detect a device availability status of the device; and
present to the user:
the contact availability status of respective contacts using an availability status indicator selected from the availability status indicator set, and
the device availability status of respective devices using an availability status indicator selected from the availability status indicator set.

2. The method of claim 1, detecting the device availability status of a device comprising:
sending a device availability query to the device,
receiving a device availability report from the device.

3. The method of claim 1, the device availability status of a device presented to the computer by a device availability server.

4. The method of claim 3, the instructions configured to report the availability status of the computer to the device availability server.

5. The method of claim 4, reporting the availability status of the computer comprising: reporting the availability status of the computer to the device availability server at an availability frequency.

6. The method of claim 4, reporting the availability status of the computer comprising: reporting the availability status of the computer to the device availability server upon receiving an availability request from the device availability server.

7. The method of claim 1:
the availability status indicator set including at least one additional availability status indicator associated with at least one additional device availability status; and
presenting the device availability status of a device comprising: presenting to the user the additional device availability status using the additional availability status indicator from the availability status indicator set.

8. The method of claim 1, presenting the device availability status comprising: presenting with the device availability status indicator a device depiction of the device.

9. The method of claim 8:
the device associated with a device type;
the computer having at least two device depictions respectively depicting devices of a device type; and
presenting the device depiction comprising: representing a device depiction representing the device type of the device.

10. The method of claim 1, presenting the device availability status comprising: presenting a device availability status message describing the availability status of the device.

11. The method of claim 10:
the user associated with a culture;
the device having at least one device availability status message associated with a culture; and
presenting the device availability status comprising: presenting a device availability status message describing the availability status of the device and associated with the culture of the user.

12. The method of claim 1, the device operated by a second user other than the user and having an availability status shared with the user.

13. The method of claim 12:
the second user using at least one device; and
presenting the availability statuses to the user comprising: associating the contact availability status of the second user with the device availability status of the device.

14. The method of claim 1, presenting the availability statuses to the user comprising: presenting the contact availability status of the at least one contact together with the device availability status of the at least one device.

15. The method of claim 1, presenting a device availability status of a device comprising: presenting with the device availability status at least one device action.

16. The method of claim 15, at least one device action associated with the device availability status of the device.

17. The method of claim 16, at least one device action associated with the device availability status of the device and a second device availability status of a second device.

18. The method of claim 16, at least one device action associated with the device availability status of the device and the contact availability status of a contact.

19. A system configured to present availability statuses of devices and contacts to a user, the system comprising:
an availability status indicator set including an available indicator, a busy indicator, and an unavailable indicator;
a contact availability status determining component configured to, for respective contacts, detect a contact availability status of the contact;
a device availability status determining component configured to, for respective devices, detect a device availability status of the device; and
an availability status presenting component configured to present to the user:
the contact availability status of respective contacts using an availability status indicator selected from the availability status indicator set, and
the device availability status of respective devices using an availability status indicator selected from the availability status indicator set.

20. A computer-readable medium comprising instructions that, when executed on a processor of a device having at least one device availability status message associated with a culture and an availability status indicator set including an available indicator, a busy indicator, and an unavailable indicator, present availability statuses of devices and contacts to a user associated with a culture by:
reporting the availability status of the computer to a device availability server at an availability frequency;
upon receiving an availability request from the device availability server, reporting the availability status of the computer to the device availability server;
for respective contacts, detecting a contact availability status of the contact;
for respective devices, detecting a device availability status of the device from the device availability server;
presenting to the user:
the contact availability status of respective contacts using an availability status indicator selected from the availability status indicator set, and
for respective devices:
the device availability status using an availability status indicator selected from the availability status indicator set;
a device availability status message associated with the culture of the user and describing the availability status of the device;
a device depiction of the device; and
at least one device action associated with the device availability status of the device.
